(19) United States
(12) Patent Application Publication
(10) Pub. No.: US 2020/0179908 A1
(43) Pub. Date: Jun. 11, 2020

(54) PROMOTER METAL CONTAINING PEROVSKITE-TYPE COMPOUND FOR GASOLINE EXHAUST GAS APPLICATIONS

(71) Applicant: JOHNSON MATTHEY PUBLIC LIMITED COMPANY, London (GB)

(72) Inventors: Kerry Simmance, Reading (GB); David Thompsett, Reading (GB)

(21) Appl. No.: 16/701,313

(22) Filed: Dec. 3, 2019

Related U.S. Application Data
(60) Provisional application No. 62/775,092, filed on Dec. 4, 2018.

(51) Int. Cl. B01J 23/83; B01J 23/889; B01J 23/00; B01J 35/10; B01J 35/02; B01J 35/08; B01J 37/04; B01J 37/00; B01J 37/02; B01J 37/08; B01D 53/94

(52) U.S. Cl. CPC B01J 23/83; B01D 2255/2073; B01J 23/002; B01J 35/1009; B01J 35/023; B01J 35/08; B01J 37/04; B01J 37/0072; B01J 37/0201; B01J 37/088; B01D 53/945; B01D 2255/2063; B01D 2255/20738; B01D 2255/20761; B01D 2255/908; B01D 2255/204; B01J 23/8892

(57) ABSTRACT

A three-way catalyst composition, and its use in an exhaust system for internal combustion engines, is disclosed. The composition can comprise a compound of formula (I): A_{x-y}A′_{y}B_{1-z}B′_{z}O₃ and a promoter metal component, wherein A is an ion of a metal of group 2 or 3 of the periodic table of elements; wherein A′ is an ion of a metal of group 1, 2, or 3 of the periodic table of elements; wherein B and B′ are ions of metal of groups 4, 6, 7, 8, 9, 10, 11, or 13 of the periodic table of elements; wherein x is from 0.7 to 1; wherein y is from 0 to 0.5; and wherein z is from 0 to 0.5.

### FIELD OF THE INVENTION

The invention relates to a novel promoter metal (e.g., Cu) containing perovskite-type composition, its use as a three-way catalyst (TWC) in exhaust systems for internal combustion engines, and a method for treating an exhaust gas from an internal combustion engine.

### BACKGROUND OF THE INVENTION

Internal combustion engines produce exhaust gases containing a variety of pollutants, including hydrocarbons (HCs), carbon monoxide (CO), and nitrogen oxides (“NOₓ”). Emission control systems, including exhaust gas catalysts, are widely utilized to reduce the amount of these pollutants emitted to atmosphere. A commonly used catalyst for gasoline engine applications is the TWC. TWCs perform three main functions: (1) oxidation of carbon monoxide (CO); (2) oxidation of unburnt hydrocarbons; and (3) reduction of NOₓ to N₂.

TWCs that usually consist of Platinum Group Metals (PGMs) dispersed over high surface area alumina and ceria-zirconia supports, were first introduced in the early 1980s for gasoline engine aftertreatment. With the need to meet increasingly more stringent emission limits, identifying alternative catalyst compositions which utilise either lower or no PGMs remains an active research topic. Perovskite-type oxides (ABO₃) have been long proposed as TWCs. Although there has been a continuous effort to understand and improve the catalytic properties of perovskites for automotive applications, conventional synthesis methods such as co-precipitation and thermal crystallization give materials with low surface areas, which may hamper optimisation of catalytic properties. Thus, there are still needs to improve and synthesize novel TWC compounds with high surface area and/or optimized catalytic properties.

### SUMMARY OF THE INVENTION

One aspect of the present disclosure is directed to a composition comprising a perovskite type compound of formula (I): A_{x-y}A′_{y}B_{1-z}B′_{z}O₃ and a promoter metal component, wherein A is an ion of a metal of group 2 or 3 of the periodic table of elements; wherein A′ is an ion of a metal of group 1, 2, or 3 of the periodic table of elements; wherein B and B′ are ions of metal of groups 4, 6, 7, 8, 9, 10, 11, or 13 of the periodic table of elements; wherein x is from 0.7 to 1; wherein y is from 0 to 0.5; and wherein z is from 0 to 0.5.

Another aspect of the present disclosure is directed to a three-way catalyst comprising a composition of the first aspect of the present disclosure.

The invention also encompasses an exhaust system for internal combustion engines that comprises the three-way catalyst component of the invention

The invention also encompasses treating an exhaust gas from an internal combustion engine, in particular for treating exhaust gas from a gasoline engine. The method comprises contacting the exhaust gas with the three-way catalyst component of the invention.

### BRIEF DESCRIPTION OF THE DRAWINGS

FIG. 1 shows an illustration of Flame Spray Pyrolysis (FSP).

FIG. 2a shows a TEM image of Comparative Catalyst 1A, highlighting the spherical morphology with appropriate lattice fringe analysis/planes shown; FIG. 2b shows a TEM image of Comparative Catalyst 1A with evidence of amorphous/disordered surfaces and the crystalline core/bulk; FIG. 2c shows a TEM image of Comparative Catalyst 1A, highlighting how the small primary nanoparticles can agglomerate to form larger particles.

FIG. 3a shows the CO conversion as a function of temperature under simulated gasoline conditions with lambda=0.99±0.05 (ramp 2) for Catalyst 1B compared to Comparative Catalysts 1A and 1C; FIG. 3b shows the total hydrocarbon (C₃H₆+C₃H₈) conversion as a function of temperature under simulated gasoline conditions with lambda=0.99±0.05 (ramp 2) for Catalyst 1B compared to Comparative Catalysts 1A and 1C; FIG. 3c shows the NO conversion as a function of temperature under simulated gasoline conditions with lambda=0.99±0.05 (ramp 2) for Catalyst 1B compared to Comparative Catalysts 1A and 1C.

FIG. 4 shows the hydrogen temperature programmed reduction (H₂-TPR) profiles as a function of temperature under 10% H₂/N₂ gas feed for Catalyst 1B compared to Comparative Catalyst 1A and 1C.

FIG. 5 shows the total oxygen storage capacity (OSC) as a function of temperature for Catalyst 1B compared to Comparative Catalyst 1A and 1C. Total OSC is calculated from CO₂ breakthrough curves in a CO/O₂ switching study.

FIG. 6 shows the CO conversion under steady state stoichiometric (λ=1.00) full gas conditions for Catalysts 4B, 4D, 4F of the present invention compared to Comparative Catalysts 4A, 4C and 4E.

FIG. 7a shows the CO conversion under steady state lean (λ=1.02) full gas conditions for Catalysts 4F-4I of the present invention compared to Comparative Catalyst 4E. FIG. 7b shows the NO conversion under steady state rich (λ=0.98) full gas conditions for Catalysts 4F-4I of the present invention compared to Comparative Catalyst 4E.

FIG. 8 shows the total oxygen storage capacity (OSC) as a function of temperature for Catalysts 4F-4I compared to Comparative Catalyst 4E. Total OSC is calculated from CO₂ breakthrough curves in a CO/O₂ switching study.

### DETAILED DESCRIPTION OF THE INVENTION

One aspect of the present disclosure is directed to a composition comprising a perovskite type compound of formula (I): A_{x-y}A′_{y}B_{1-z}B′_{z}O₃ and a promoter metal component, wherein A is an ion of a metal of group 2 or 3 of the periodic table of elements; wherein A′ is an ion of a metal of group 1, 2, or 3 of the periodic table of elements; wherein B and B′ are ions of metal of groups 4, 6, 7, 8, 9, 10, 11, or 13 of the periodic table of elements; wherein x is from 0.7 to 1; wherein y is from 0 to 0.5; and wherein z is from 0 to 0.5.

A of the compound of formula (I) can be Mg, Sr, Ba, Ca, Y, La, Ce, Pr, Nd, or Gd. In preferred embodiments, A is La, Y, Sr; most preferably, A is La.

A′ of the compound of formula (I) can be Na, K, Cs, Mg, Sr, Ba, Ca, Y, La, Ce, Nd, or Gd. In preferred embodiments, A′ is Sr, Ca, Y, or Ce.

B of the compound of formula (I) can be Mn, Co, Fe, Ni, Cr, Ti, Zr, Al, or Ga. In preferred embodiments, B is Mn, Co, Fe, or Ni; more preferably, B is Mn or Fe; most preferably, B is Fe.

B′ of the compound of formula (I) can be Cu, Mn, Co, Fe, Ni, Cr, Ti, Zr, Al, or Ga. In preferred embodiments, B′ is Al, Fe, Co, Mn, or Cu; more preferably, B′ is Cu or Fe.

In the compound of formula (I), x can be 0.8-1, 0.9-1, 0.7-0.9, or 0.7-0.8.

In the compound of formula (I), y can be 0-0.4, 0-0.3, 0-0.2, or 0-0.1.

In the compound of formula (I), z can be 0-0.5, 0-0.4, 0-0.3, 0-0.2, or 0-0.1. In some embodiments, z is 0.

The compound of formula (I) can be prepared by co-precipitation, flame spry pyrolysis (FSP), etc.

FSP can be a combustion method in which soluble precursors in organic solvents are combusted in a CH₄/O₂ flame to directly give nano-crystalline particles.

Co-precipitation is not necessarily a one-step process unlike the other methods, here precursors in a solution are mixed together and slowly precipitated together through pH control to form a well-mixed amorphous-like precipitate which is then calcined to produce crystalline particles of perovskite phase.

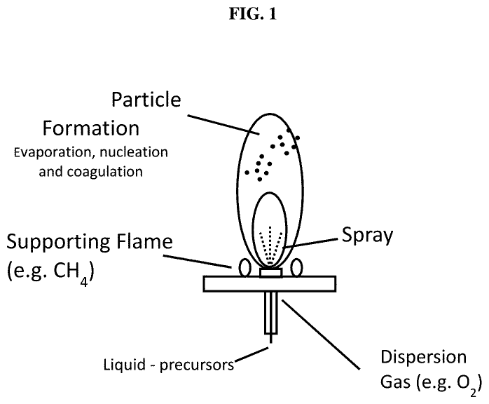

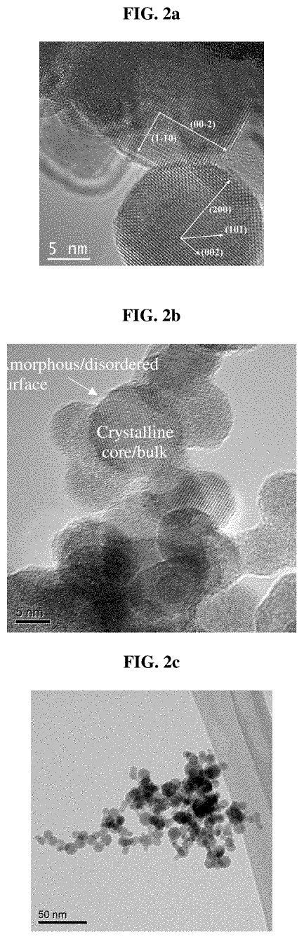

The compound of formula (I) can be prepared by Flame Spray Pyrolysis (FSP) (e.g., see FIG. 1). For example, FSP can be a combustion method in which soluble precursors in organic solvents are combusted in a CH₄/O₂ flame to directly give nano-crystalline particles. The compound of formula (I) can have a mean primary crystal size of less than 60 nm. In some preferred embodiments, the compound of formula (I) has a mean primary crystal size of less than 30, 25, 20, 15, 10, or 5 nm. In other preferred embodiments, the compound of formula (I) has a mean primary crystal size of 5 nm-60 nm, 5 nm-50 nm, 5 nm-40 nm, 5 nm-30 nm or 5 nm-20 nm. The compound of formula (I) can be at least 90% phase pure. It is more preferred to be at least 95%, 96%, 97%, 98% or 99% phase pure. The compound of formula (I) can have a primary particle morphology of spherical shape. (E.g., see FIG. 2a). The compound of formula (I) can have a disordered surface as evidenced by TEM. (E.g., see FIG. 2b).

As used herein, the term “percent” in connection with the perovskite materials means:

percent purity=I_{perovskite phase}/(I_{perovskite phase}+I_{impurity phase})

I=intensity of crystalline phase, as identified by XRD.

Alternatively, the compound of formula (I) can have a primary particle morphology of hexagonal, cubic, rod, flower or faceted shape.

The compound of formula (I) can have a surface composition range of (A+A′)/(B+B′) between 0.5 and 3.0, preferably between 0.5 and 2.0, measured by XPS. The surface composition ranges of (A+A′)/(B+B′) can also be from 0.5 to 1.5, 0.5 to 1.0, 1.0 to 2.0, or 1.0 to 1.5.

Perovskites prepared by FSP can have an average primary particle size ranging between 5 and 20 nm with a primary particle morphology of spherical shape as highlighted in the TEM images (FIGS. 2a-2c) for a LaFeO₃ based perovskite. The crystallite size as calculated from XRD also agrees with the primary particle size observed by TEM. The nano-crystalline material has a somewhat disordered/amorphous-like surface as evidenced by TEM (FIG. 2b), which may enhance its activity for TWC by allowing for more oxygen vacancies to be created at the surface and/or a higher concentration of active B site cations at the surface. The primary nanoparticles agglomerate to form larger particles which can be of micron size in their powder form but still retain a high surface area (e.g., >40 m²g⁻¹). The high surface area allows for: a higher concentration of active B cations to be present at the surface as evidenced by XPS, a higher concentration of surface oxygen vacancies as evidenced by O₂-TPD, and improved reducibility of the B cation at temperatures below 500° C. as evidenced by H₂-TPR.

The phase purity of the compound of formula (I) is also important for optimum activity; the presence of other crystalline phases, such as La(OH)₃, La₂O₃, Fe₂O₃ etc., results in lower activity. Compared to perovskites prepared by traditional methods, a perovskite prepared by FSP can have a primary particle morphology of spherical shape with a size ranging from 5-60 nm, preferably from 5-30 nm, which may aggregate but retain a high surface area above 40 m²g⁻¹ and have a disordered surface.

Alternatively, the specific surface area of the compound of formula (I) can be at least 6 m²/g, 8 m²/g, 20 m²/g, 30 m²/g, or 40 m²/g.

The promoter metal may be any of the recognized catalytically active metals that are used in the catalyst industry, particularly those metals that are known to be catalytically active for treating exhaust gases derived from a combustion process. Promoter metal should be broadly interpreted and specifically includes copper, nickel, zinc, iron, tungsten, molybdenum, cobalt, titanium, zirconium, manganese, chromium, vanadium, niobium, as well as tin, bismuth, and antimony. Preferred transition metals are base metals, and preferred base metals include those selected from the group consisting of chromium, manganese, iron, cobalt, nickel, and copper, and mixtures thereof. More preferred base metals include those selected from the group consisting of iron, cobalt, nickel, manganese and copper, and mixtures thereof. In preferred embodiments, the promoter metal is copper, manganese, iron, or a combination thereof. In more preferred embodiments, the promoter metal is copper.

The promoter metal containing perovskite compound composition described above may be obtained via any known technique, such as impregnation methods.

The promoter metal may be present in the composition at a concentration of up to 20 weight percent (wt %) based on the total weight of the composition, for example from 0.1 wt % to 20 wt %, 0.5 wt % to 10 wt %, from 0.5 to 1 wt %, from 1 to 5 wt %, or 2 wt % to 4 wt %. For embodiments which utilize copper, iron, or the combination thereof, the concentration of these promoter metals in the composition is preferably 1 to 15 weight percent, more preferably 1 to 10 weight percent, 1 to 5 weight percent, or 1 to 3 weight percent.

Another aspect of the present disclosure is directed to a three-way catalyst comprising a composition as described above in the first aspect of the present invention.

The three-way catalysts of the present invention have been evaluated for their TWC activity under simulated gasoline exhaust feeds and their oxygen storage properties (E.g., see Examples 2, 3, and 5). Compared to the un-promoted perovskite support reference, the catalysts of the present invention have improved oxidation (CO and THC) function with lower light-off temperatures and higher conversions (400-500° C.) under perturbed gasoline SCAT conditions. The NO conversion and light-off temperatures are comparable to a reference catalyst under perturbed SCAT conditions, however the promoted catalysts show improved N₂ selectivity. Furthermore, under steady state rich testing conditions, the promoted catalysts show improved NO reduction capability compared to the un-promoted perovskite support reference. In addition, the promoted catalysts show improved oxygen storage properties (OSC) over a wide temperature window (250-500° C.). These advantages compared to the reference catalyst remain after high temperature redox ageing.

The invention also encompasses an exhaust system for internal combustion engines that comprises the three-way catalyst component of the invention. In the exhaust system, the three-way catalyst component may be placed in a close-coupled position or in the underfloor position.

The invention also encompasses treating an exhaust gas from an internal combustion engine, in particular for treating exhaust gas from a gasoline engine. The method comprises contacting the exhaust gas with the three-way catalyst component of the invention.

The following examples merely illustrate the invention. Those skilled in the art will recognize many variations that are within the spirit of the invention and scope of the claims.

### EXAMPLES

Materials produced in the examples described below were characterized by one or more of the following analytic methods. Powder X-ray diffraction (PXRD) patterns were collected on a Bruker D8 powder diffractometer using a CuKα radiation (40-45 kV, 40 mA) at a step size of 0.04° and a 1 s per step between 5° and 100° (2θ). Transmission electron microscopy (TEM) images were obtained on a JEM 2800 (Scanning) TEM with 200 kV Voltage. The micropore volume and surface area were measured using N₂ at 77 K on a 3Flex surface characterization analyzer (Micromeritics).

### Reagents:

Lanthanum(III) 2-ethylhexanoate solution (Molekular), lanthanum(III) 2-ethylhexanoate solid (American Element), strontium(II) 2-ethylhexanoate (Alfa, 40% in 2-ethylhexanoic acid), strontium(II) acetate hemihydrate (Alfa), iron(II) naphthenate (80% in mineral spirits, Alfa), iron(III) acetylacetonate (Alfa), copper(II) acetate anhydrous (Alfa, 98%), manganese(II) 2-theylhexanoate (Alfa, 40% in 2-ethylhexanoic acid), cobalt(II) acetylacetonate (Sigma-Aldrich), xylene (Alfa), ethanol (Alfa), 2-ethylhexanoic acid (Alfa, 99%), copper(II) nitrate trihydrate (Sigma-Aldrich), nickel(II) nitrate hexahydrate (Sigma-Aldrich), cobalt(II) nitrate hexahydrate (Sigma-Aldrich), Iron(III) oxide (Sigma-Aldrich), Lanthanum (III) oxide (Alfa).

### Flame Spray Pyrolysis (FSP):

A FSP perovskite material is typically synthesized by liquid feed flame pyrolysis.

The precursors are dissolved in a suitable solvent at a specific temperature. The solution is then fed with an oxygen stream into a flame. The particles are conveyed through stainless steel ducting to a bag house with air filter bag and recovered by back-pulsing the filter bag.

### Wet Impregnation:

The promoted catalyst was prepared through wet impregnation methods using a metal salt precursor, typically copper (II) nitrate, dissolved in water and added with good mixing to the perovskite material at a 70% pore fill volume. This material is then dried and calcined at 500° C. resulting in the promoted catalyst reported here in.

### Example 1-Catalysts Preparation and their Analyses

Comparative Catalyst 1A (La_{0.8}FeO₃):

Lanthanum(III) 2-ethylhexanoate solution (27.78 g, 0.02 mole) and iron(III) acetylacetonate (8.84 g, 0.025 mole) were dissolved in 150 mL of xylene. The solution (200 mL, 0.33 mol/L) was then fed with an oxygen stream (dispersion and sheath flow rate 20 L/min) into a CH₄/O₂ flame (1.5/3.2 L/min mix) at a rate of 10 mL/min. The particles were conveyed through stainless steel ducting to a bag house with air filter bag (Whatman GF/D filter papers) and recovered by back-pulsing the filter bag. The resulting Comparative Catalyst 1A was phase pure with an average crystallite size of 12 nm as evidenced by XRD. Comparative Catalyst 1A had a specific surface area of 80 m²g⁻¹ with spherical particle morphology and a surface composition of La/Fe=1.1 (XPS).

As shown in the TEM images in FIGS. 2a-2c for Comparative Catalyst 1A. The crystallite size as calculated from XRD was consistent with the primary particle size observed by TEM. The nano-crystalline material had a somewhat disordered/amorphous-like surface as evidenced by TEM (FIG. 2b), which may enhance its activity for TWC by allowing for more oxygen vacancies to be created at the surface and/or a higher concentration of active B site cations at the surface. The primary nanoparticles agglomerate to form larger particles which can be of micron size in their powder form but still retain a high surface area (e.g., >40 m²g⁻¹). The high surface area allows for: a higher concentration of active B cations to be present at the surface as evidenced by XPS, a higher concentration of surface oxygen vacancies as evidenced by O₂-TPD and improved reducibility of the B cation at temperatures below 500° C. as evidenced by H₂-TPR.

Catalyst 1B (2 wt % Cu La_{0.8}FeO₃):

The promoted catalyst, Catalyst 1B, was prepared by adding Cu to Comparative Catalyst 1A through incipient wetness impregnation. An aqueous solution of Cu(NO₃)₂.3H₂O and a 70% pore fill volume was used prior to calcination at 500° C. for 2 hours. The preferred copper loading was 2 weight %. The resulting Catalyst 1B was phase pure perovskite phase with an average crystallite size of 12 nm as evidenced by XRD. Catalyst 1B had spherical particle morphology.

Comparative Catalyst 1C (La_{0.8}Cu_{0.2}Fe_{0.8}O₃):

First, copper(II) acetate (1.37 g, 0.005 mole) and iron(III) acetylacetonate (10.61 g, 0.02 mole) were dissolved in 180 mL of a 1:1 mixture of ethanol and 2-ethylhexanoic acid. The resulting solution (28.40 g) containing a mixture of copper(II) 2-ethylhexanoate (0.005 moles) and iron(III) 2-ethylhexanoate (50% cone, 0.02 moles) was mixed with lanthanum(III) 2-ethylhexanoate solution (38.58 g, 0.02 mole) and 180 mL of xylene. The solution (225 mL, 0.33 mol/L) was then fed with an oxygen stream (dispersion and sheath flow rate 5 L/min) into a CH₄/O₂ flame (1.5/3.2 L/min mix) at a rate of 5 mL/min. The particles were conveyed through stainless steel ducting to a bag house with air filter bag (Whatman GF/D filter papers) and recovered by back-pulsing the filter bag. The resulting Comparative Catalyst 1C was phase pure with an average crystallite size of 12 nm as evidenced by XRD. Comparative Catalyst 1C had a specific surface area of 47 m²g⁻¹ with spherical particle morphology.

### Example 2: Light-Off Testing Procedures for Example 1

After calcination at 500° C. for 2 hours, Comparative Catalysts 1A and 1C and Catalyst 1B were tested under a continuous gas mix with a typical TWC gas composition. The samples were tested from 110 to 500° C. using a ramp rate of 10° C./min. The total flow used was 5 L/min for 0.2 g of catalyst mixed with 0.2 g of cordierite, which was placed in a fix bed reactor. The gases used and their concentrations can be found below (Table 1).

TABLE 1
Gas mix composition for the light-off experiments

Perturbed SCAT test

| | Base mix | +pert. line |
|---|---|---|
| Lambda | 0.99/1.01 | 0.05 |
| Time | 3 sec | 3 sec |

| | |
|---|---|
| NO | 2200 ppm |
| CO₂ | 14% |
| H₂O | 4% |

| | | |
|---|---|---|
| CO | 0.73% | 1.47% |

| | |
|---|---|
| C₃H₆ | 666 ppm |
| C₃H₈ | 333 ppm |

| | | |
|---|---|---|
| H₂ | 0.23% | 0.46% |
| O₂ | Dependable on λ | 1% |

| | |
|---|---|
| Ramp rate | 10° C./min |
| Max Temp | 500° C. |
| WHSV | 750 Lg⁻¹h⁻¹ |

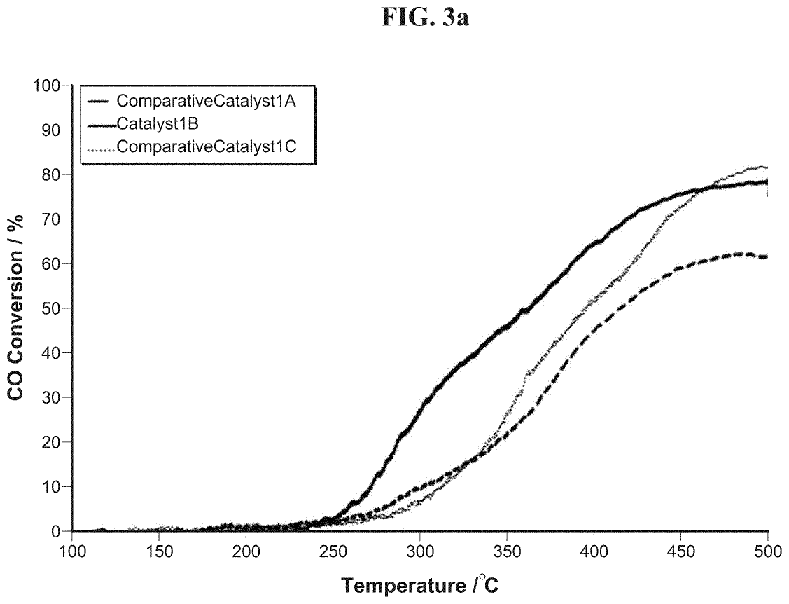

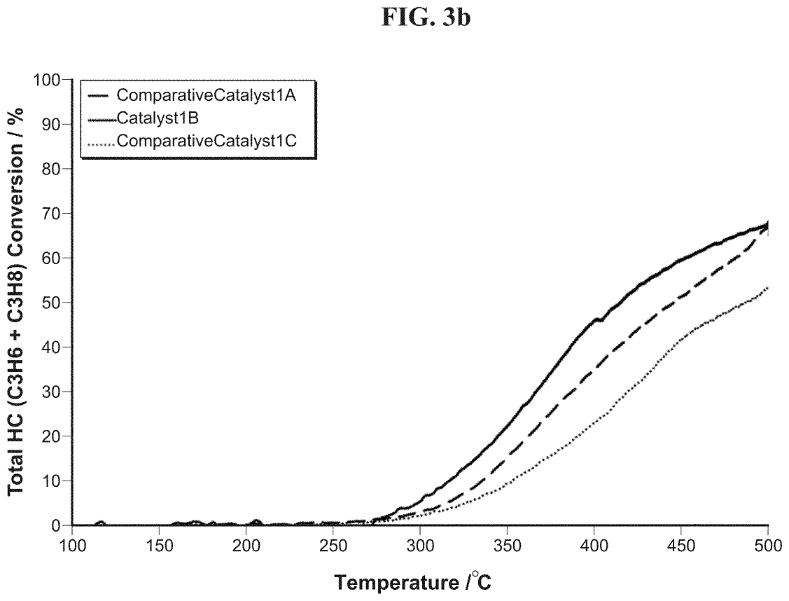

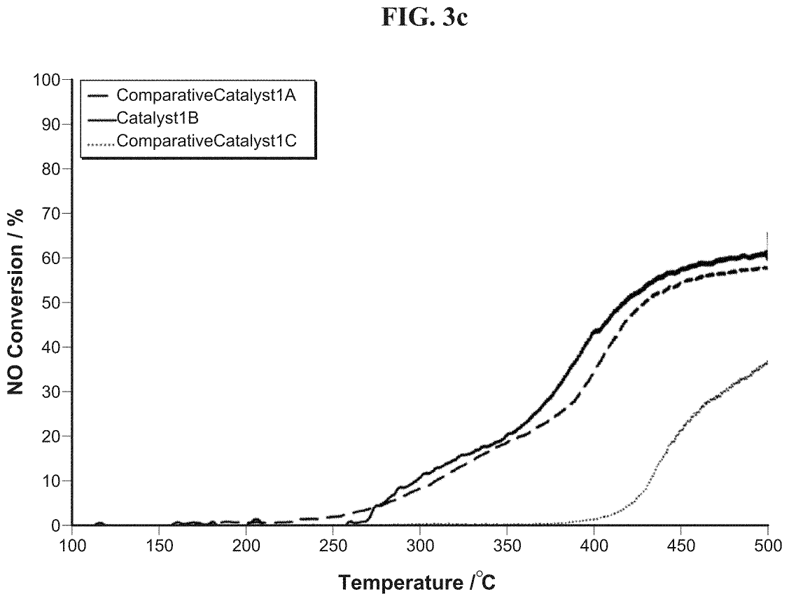

The results showed that the catalyst of the invention (Catalyst 1B) has improved CO/HC performance (including light-off) and comparable NO performance, compared to Comparative Catalyst 1A at a realistic operating temperature of 500° C. (FIGS. 3a-3d). Furthermore, the catalyst of the invention (Catalyst 1B) has improved N₂ selectivity compared to Comparative Catalysts 1A Table 2. In addition, results clearly highlight the importance of adding the promoter metal (in this case Cu) to the catalyst through post-synthesis methods; Catalyst 1B has not only improved CO/HC performance but also improved NO performance compared to Comparative Catalyst 1C in which the promoter metal was added during the FSP process in substitute for Fe.

TABLE 2
Catalysts Performances at 500° C.,
highlighting N₂ selectivity differences

| | Conversion/Selectivity at 500° C. | | |
|---|---|---|---|
| | NO Conv. (%) | NH₃ selectivity (%) | N₂ selectivity (%) |
| Comparative | 59 | 70 | 29 |
| Catalyst 1A | | | |
| Catalyst 1B | 63 | 34 | 65 |
| Comparative | 37 | 17 | 82 |
| Catalyst 1C | | | |

In addition, as shown in Table 3 below, at 400° C., Catalyst 1B has improved C₃H₆/NO performance and comparable CO performance, compared to Comparative Catalysts 1A and 1C under both rich and lean conditions.

TABLE 3
Catalysts Performances at 400° C.

| | CO % | | HC % | | NO % | |
|---|---|---|---|---|---|---|
| | λ = | λ = | λ = | λ = | λ = | λ = |
| | 0.99 | 1.01 | 0.99 | 1.01 | 0.99 | 1.01 |
| Comparative | 55 | 61 | 34 | 46 | 33 | 28 |
| Catalyst 1A | | | | | | |
| (La_{0.8}FeO₃) | | | | | | |
| Comparative | 62 | 88 | 23 | 39 | 2 | 2 |
| Catalyst 1C | | | | | | |
| (La_{0.8}Cu_{0.2}Fe_{0.8}O₃) | | | | | | |
| Catalyst 1B | 87 | 43 | 59 | 49 | 36 | 43 |
| (2% Cu/La_{0.8}FeO₃) | | | | | | |

### Example 3: Oxygen Storage Capacity (OSC) and Temperature Programmed Reduction (TPR) Procedure for Example 1

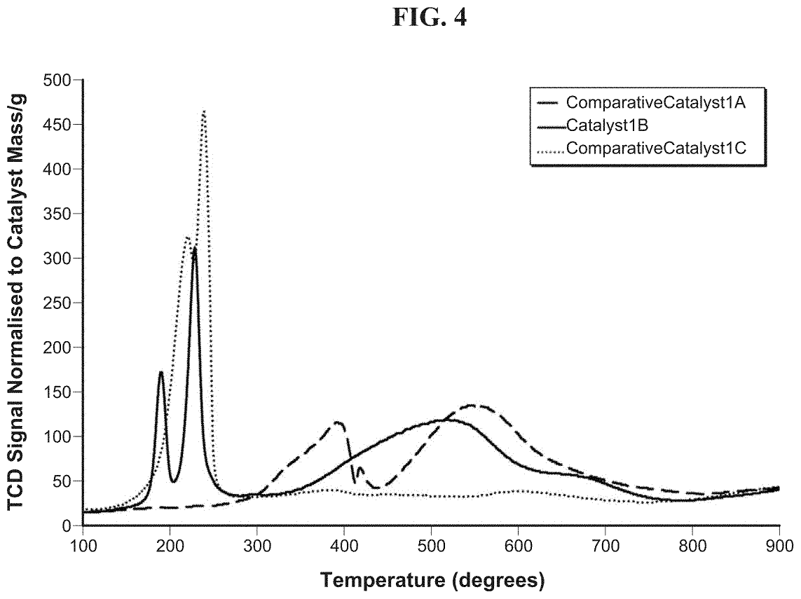

The reducibility of catalyst was determined by H₂ temperature-programmed reduction (TPR); a 0.2 g sample of the perovskite catalyst was reduced in 10% H₂/Ar (30 ml/min) as the temperature was increased from room temperature to 950° C. at a rate of 10° C./min. A thermal conductivity detector (TCD) was used to measure H₂ consumption, and the detector output was normalised to the exact mass of the catalyst. A H₂O and CO₂ trap was placed before the TCD. H₂-TPR experiments clearly show the presence of both a low temperature (150-300° C.) and a high temperature reduction peak (350-600° C.) for the catalyst of the invention compared to Comparative Catalyst 1A and Comparative Catalyst 1C which only show a large reduction peak in either the low temperature or high temperature region and not both. (FIG. 4)

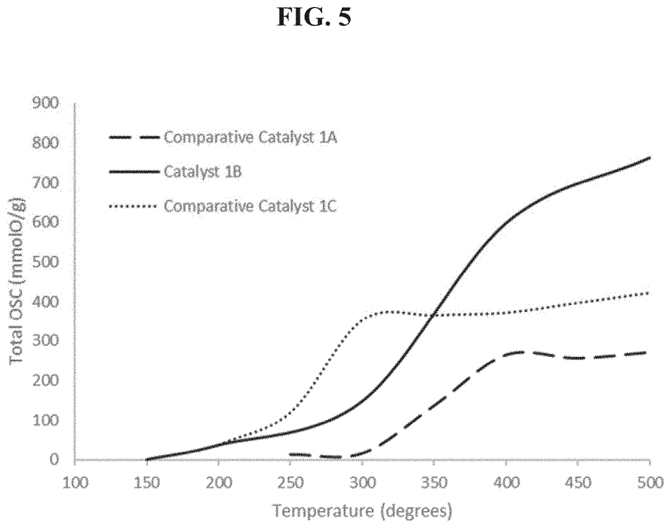

After calcination at 500° C. for 2 hours, the oxygen storage capacity (OSC) of Comparative Catalysts 1A and 1C and Catalyst 1B was determined using a CO/CO₂ breakthrough test which monitors the CO₂ generation from the stored O₂ of the catalyst under dynamic conditions. Approximately 0.1 g of catalyst was exposed to alternate lean (10 ml min⁻¹ of 5% O₂/He for 5 mins) and rich (10 ml min⁻¹ of 10% CO/He for 5 mins) gas mixtures using He as a carrier gas (90 ml min⁻¹ He). A mass spectrometer was used to monitor the CO₂, CO and O₂ signals, at 50° C. temperature intervals, over three redox cycles and the OSC calculated from measuring the time taken between the CO₂ and CO breakthrough signals. The results showed that the catalyst of the invention (Catalyst 1B) has improved OSC compared to Comparative Catalyst 1A over the whole temperature range. Furthermore, a large improvement in the high temperature (>350° C.) OSC is also observed for the catalyst of the invention compared to Comparative Catalyst 1C (FIG. 5)

### Example 4-Additional Catalysts Preparation and their Analyses

Comparative Catalyst 4A (La_{0.9} Sr_{0.1}FeO₃):

Lanthanum(III) 2-ethylhexanoate solution (31.25 g, 0.0225 mole), strontium(II) 2-ethylhexanoate (40% in 2-ethylhexanoic acid) (2.31 g, 0.0025 mole) and iron(II) naphthenate (80% in mineral spirits) (11.57 g, 0.025 mole) were dissolved in 100 mL of xylene. The solution (150 mL, 0.5 mol/L) was then fed with an oxygen stream (dispersion and sheath flow rate 5 L/min) into a CH₄/O₂ flame (1.5/3.2 L/min mix) at a rate of 5 mL/min. The particles were conveyed through stainless steel ducting to a bag house with air filter bag (Whatman GF/D filter papers) and recovered by back-pulsing the filter bag. The resulting Comparative Catalyst 4A was 90% phase pure with an average crystallite size of 20 nm as evidenced by XRD. Comparative Catalyst 4A had a specific surface area of 88 m²g⁻¹ with spherical particle morphology and a surface composition of La+Sr/Fe=3.0 (XPS).

Catalyst 4B (2 wt % Cu La_{0.9} Sr_{0.1}FeO₃):

The promoted catalyst, Catalyst 4B, was prepared by adding Cu to Comparative Catalyst 4A through incipient wetness impregnation. An aqueous solution of Cu(NO₃)₂.3H₂O and a 70% pore fill volume was used prior to calcination at 500° C. for 2 hours. The preferred copper loading was 2 weight %. The resulting Catalyst 4B was unchanged in terms of crystalline phase as evidenced by XRD when compared to Comparative Catalyst 4A with an average crystallite size of 20 nm.

Comparative Catalyst 4C (La_{0.9}Sr_{0.1}Fe_{0.8}Co_{0.2}O₃):

Following similar procedures as described in Example 1 above, Lanthanum(III) 2-ethylhexanoate solution, strontium(II) acetate hemihydrate, iron(II) naphthenate (80% in mineral spirits) and cobalt(II) acetylacetonate were used for the synthesis. The resulting Comparative Catalyst 4C was 90% phase pure with an average crystallite size of 9.5 nm, as evidenced by XRD. Comparative Catalyst 4C had a specific surface area of 50 m²g⁻¹ with spherical particle morphology and a surface composition of La+Sr/Fe+Co=2.8 (XPS).

Catalyst 4D (2 wt % Cu La_{0.9}Sr_{0.1}Fe_{0.8}Co_{0.2}O₃):

The promoted catalyst, Catalyst 4D, was prepared by adding Cu to Comparative Catalyst 4C through incipient wetness impregnation. An aqueous solution of Cu(NO₃)₂.3H₂O and a 70% pore fill volume was used prior to calcination at 500° C. for 2 hours. The preferred copper loading was 2 weight %. The resulting Catalyst 4D was unchanged in terms of crystalline phase as evidenced by XRD when compared to Comparative Catalyst 4C with an average crystallite size of 9.5 nm.

Comparative Catalyst 4E (La_{0.9}Sr_{0.1}MnO₃):

Following similar procedures as described in Example 1 above, Lanthanum(III) 2-ethylhexanoate solution, strontium(II) acetate hemihydrate and manganese(II) 2-ethylhexanoate were used for the synthesis. The resulting Comparative Catalyst 4E was phase pure with an average crystallite size of 7.6 nm, as evidenced by XRD. Comparative Catalyst 4E had a specific surface area of 80 m²g⁻¹ with spherical particle morphology.

Catalyst 4F (2 wt % Cu La_{0.9}Sr_{0.1}MnO₃):

The promoted catalyst, Catalyst 4F, was prepared by adding Cu to Comparative Catalyst 4E through incipient wetness impregnation. An aqueous solution of Cu(NO₃)₂.3H₂O and a 70% pore fill volume was used prior to calcination at 500° C. for 2 hours. The preferred copper loading was 2 weight %. The resulting Catalyst 4F was unchanged in terms of crystalline phase as evidenced by XRD when compared to Comparative Catalyst 4E with an average crystallite size of 7.6 nm.

Catalyst 4G (2 wt % Ni La_{0.9} Sr_{0.1}MnO₃):

The promoted catalyst, Catalyst 4G, was prepared by adding Ni to Comparative Catalyst 4E through incipient wetness impregnation. An aqueous solution of Ni(NO₃)₂.6H₂O and a 70% pore fill volume was used prior to calcination at 500° C. for 2 hours. The preferred nickel loading was 2 weight %. The resulting Catalyst 4G was unchanged in terms of crystalline phase as evidenced by XRD when compared to Comparative Catalyst 4E with an average crystallite size of 7.6 nm.

Catalyst 4H (2 wt % Co La_{0.9} Sr_{0.1}MnO₃):

The promoted catalyst, Catalyst 4H, was prepared by adding Co to Comparative Catalyst 4E through incipient wetness impregnation. An aqueous solution of Co(NO₃)₂.6H₂O and a 70% pore fill volume was used prior to calcination at 500° C. for 2 hours. The preferred cobalt loading was 2 weight %. The resulting Catalyst 4H was unchanged in terms of crystalline phase as evidenced by XRD when compared to Comparative Catalyst 4E with an average crystallite size of 7.6 nm.

Catalyst 4I (2 wt % Fe La_{0.9} Sr_{0.1}MnO₃):

The promoted catalyst, Catalyst 4I, was prepared by adding Fe to Comparative Catalyst 4E through incipient wetness impregnation. An aqueous solution of Fe(NO₃)₃.9H₂O and a 70% pore fill volume was used prior to calcination at 500° C. for 2 hours. The preferred iron loading was 2 weight %. The resulting Catalyst 4I was unchanged in terms of crystalline phase as evidenced by XRD when compared to Comparative Catalyst 4E with an average crystallite size of 7.6 nm.

### Example 5: Light-Off Testing Procedures and Oxygen Storage Capacity for Example 4

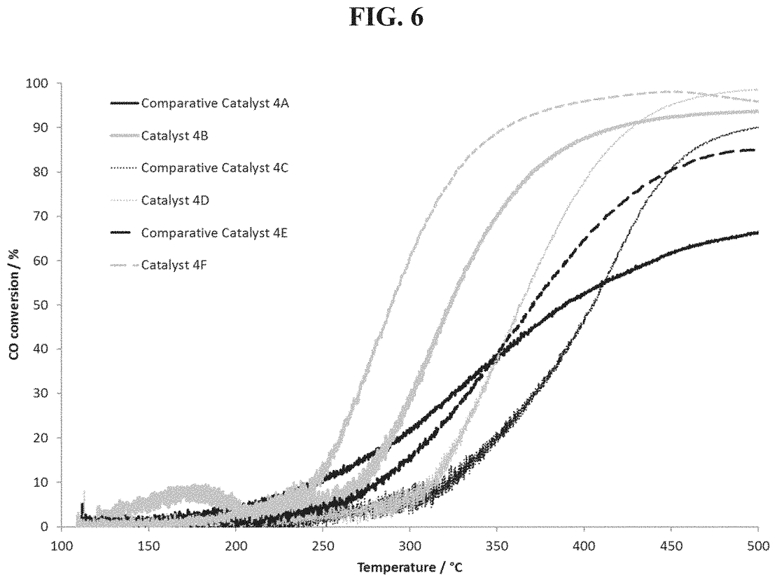

After calcination at 500° C. for 2 hours, Catalysts 4A-4I were tested under steady state SCAT test (see FIG. 6). The gases used and their concentrations can be found below (Table 4).

TABLE 4
Gas mix composition for the light-off experiments

| Steady State SCAT test | | | |
|---|---|---|---|
| | Stoichiometric | Lean | Rich |

| | | | |
|---|---|---|---|
| Lambda | 1.00 | 1.02 | 0.98 |
| Time | constant | constant | constant |

| | | | | | | |
|---|---|---|---|---|---|---|
| NO | 1000 | ppm | 1000 | ppm | 1000 | ppm |

| | | | |
|---|---|---|---|
| CO₂ | 15% | 15% | 15% |
| H₂O | 10% | 10% | 10% |
| CO | 0.7% | 0.5% | 0.9% |

| | | | | | | |
|---|---|---|---|---|---|---|
| C₃H₆ | 700 | ppm | 450 | ppm | 900 | ppm |

| | | | |
|---|---|---|---|
| H₂ | 0.233% | 0.167% | 0.3% |
| O₂ | 0.777% | 0.935% | 0.609% |

| | | | | | | |
|---|---|---|---|---|---|---|
| Ramp | 5° | C./min | 5° | C./min | 5° | C./min |
| rate | | | | | | |
| Max | 500° | C. | 500° | C. | 500° | C. |
| Temp | | | | | | |
| WHSV | 300 | Lg⁻¹h⁻¹ | 300 | Lg⁻¹h⁻¹ | 300 | Lg⁻¹h⁻¹ |

The results showed that the catalyst of the invention (Catalysts 4B, 4D, and 4F) have improved CO performances, compared to Comparative Catalysts 4A, 4C and 4E at a realistic operating temperature of 450-500° C. (FIG. 6 under stoichiometric gas composition), which is further demonstrated by the results in Table 5 below, for their performances at 400° C.

TABLE 5
Catalysts Performances at 400° C. under
steady state stoichiometric gas composition

| | CO/% | HC/% | NO/% |
|---|---|---|---|
| Comparative | 52 | 50 | 42 |
| Catalyst 4A (La_{0.9}Sr_{0.1}FeO₃) | | | |
| Catalyst 4B (2% Cu/La_{0.9}Sr_{0.1}FeO₃) | 88 | 29 | 8 |
| Comparative | 46 | 25 | 13 |
| Catalyst 4C (La_{0.9}Sr_{0.1}Co_{0.2}Fe_{0.8}O₃) | | | |
| Catalyst 4D (2% Cu/La_{0.9}Sr_{0.1}Co_{0.2}Fe_{0.8}0₃) | 78 | 10 | 2 |
| Comparative | 65 | 29 | 20 |
| Catalyst 4E (La_{0.9}Sr_{0.1}MnO₃) | | | |
| Catalyst 4F (2% Cu/La_{0.9}Sr_{0.1}MnO₃) | 96 | 29 | 11 |

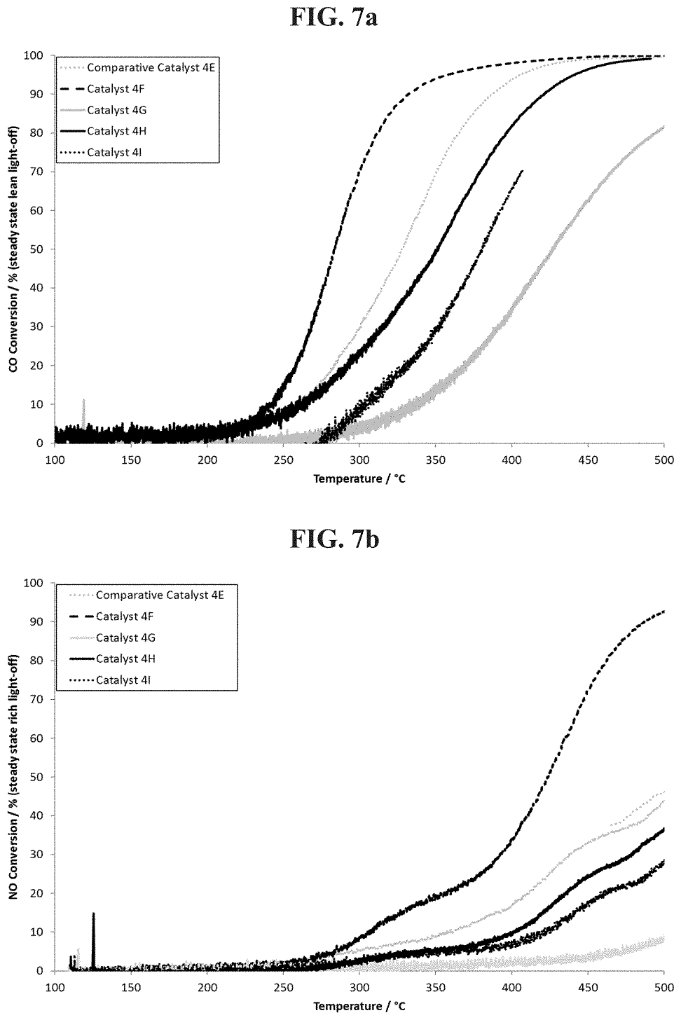

On comparison of different promoter metals for the manganese based perovskite; the results showed that only the catalyst of the invention promoted by copper (Catalysts 4F) has improved CO and NO performances, compared to Comparative Catalyst 4E and other base metal promoted catalysts, Catalysts 4G, 4H, and 4I (FIGS. 7a and 7b).

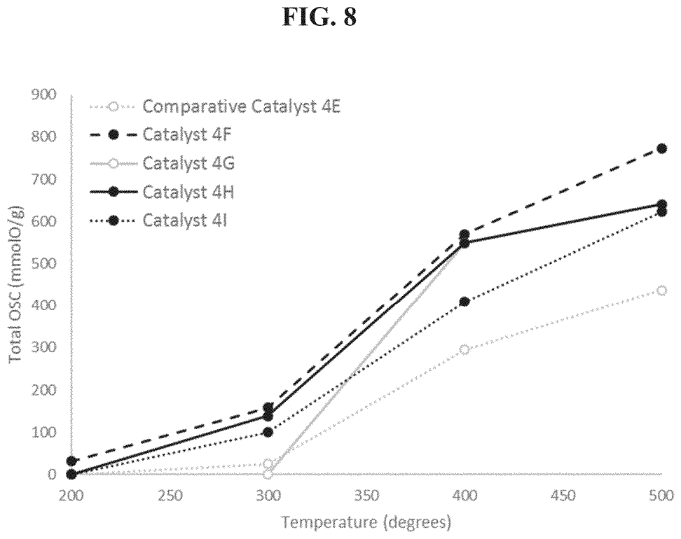

After calcination at 500° C. for 2 hours, the oxygen storage capacity (OSC) of Comparative Catalyst 4E was determined using a CO/CO₂ breakthrough test which monitors the CO₂ generation from the stored O₂ of the catalyst under dynamic conditions. Approximately 0.1 g of catalyst was exposed to alternate lean (10 ml min⁻¹ of 5% O₂/He for 5 mins) and rich (10 ml min⁻¹ of 10% CO/He for 5 mins) gas mixtures using He as a carrier gas (90 ml min⁻¹ He). A mass spectrometer was used to monitor the CO₂, CO and O₂ signals, at 50° C. temperature intervals, over three redox cycles and the OSC calculated from measuring the time taken between the CO₂ and CO breakthrough signals. The results showed that the catalysts of the invention (Catalysts 4F, 4G, 4H and 4I) have improved OSC compared to Comparative Catalyst 4E over the whole temperature range. Furthermore, a large improvement in the high temperature (>350° C.) OSC is also observed for the catalyst of the invention compared to Comparative Catalyst 4E (FIG. 8).

An additional requirement of a TWC is a need to provide a diagnosis function for its useful life, so called “on-board diagnostics” or OBD. A problem in OBD arises where there is insufficient oxygen storage capacity in the TWC, because OBD processes for TWCs use remaining oxygen storage capacity to diagnose remaining catalyst function. Since embodiments of the present invention demonstrated improved OSC performances (e.g., Catalysts 4F, 4G, 4H and 4I), the catalysts for use in such embodiments can be used with advantage in current OBD processes.

1. A composition comprising a perovskite type compound of formula (I): A_{x-y}A′_{y}B_{1-z}B′_{z}O₃ and a promoter metal component, wherein A is an ion of a metal of group 2 or 3 of the periodic table of elements; wherein A′ is an ion of a metal of group 1, 2, or 3 of the periodic table of elements; wherein B and B′ are ions of metal of groups 4, 6, 7, 8, 9, 10, 11, or 13 of the periodic table of elements; wherein x is from 0.7 to 1; wherein y is from 0 to 0.5; and wherein z is from 0 to 0.5.

2. The composition of claim 1, wherein A is Y, La, Nd, Ce, or Gd.

3. The composition of claim 2, wherein A is La or Y.

4. The composition of claim 1, wherein A′ is Sr, Ca, Y, or Ce.

5. The composition of claim 1, wherein B is Mn, Co, Fe, or Ni.

6. The composition of claim 5, wherein B is Mn or Fe.

7. The composition of claim 6, wherein B is Fe.

8. The composition of claim 1, wherein B′ is Mn, Fe, Ni, Co, or Cu.

9. The composition of claim 8, wherein B′ is Cu.

10. The composition of claim 1, wherein x is from 0.8 to 1.

11. The composition of claim 1, wherein y is from 0 to 0.4.

12. (canceled)

13. The composition of claim 1, wherein z is from 0 to 0.4.

14. (canceled)

15. The composition of claim 1, wherein the specific surface area of the compound of formula (I) is at least 8 m²/g.

16. The composition of claim 1, wherein the compound of formula (I) has a mean primary crystal size of less than 60 nm as evidenced by XRD.

17. The composition of claim 1, wherein the compound of formula (I) is at least 90% phase pure.

18. The composition of claim 1, wherein the compound of formula (I) has a spherical shape morphology.

19. The composition of claim 1, wherein the compound of formula (I) has a surface composition range of (A+A′)/(B+B′) between 0.5 and 3.0.

20. The composition of claim 1, wherein the promoter metal component is Cu, Mn, Co, Ni, or Fe.

21. The composition of claim 20, wherein the promoter metal component is Cu.

22. The composition of claim 1, wherein the promoter metal component is up to 20 wt % of the composition, based on the promoter metal element content.

23. (canceled)
